(19) United States
(12) Patent Application Publication
(10) Pub. No.: US 2014/0379783 A1
(43) Pub. Date: Dec. 25, 2014

(54) CLUSTERED DEVICE SYNCHRONIZATION

(71) Applicant: Global Golf Tour, LLC, Las Vegas, NV (US)

(72) Inventors: Amer Tadayon, Scottsdale, AZ (US); Amir Tadayon, Scottsdale, AZ (US)

(21) Appl. No.: 14/311,209

(22) Filed: Jun. 20, 2014

Related U.S. Application Data
(60) Provisional application No. 61/956,919, filed on Jun. 20, 2013.

(51) Int. Cl. H04L 29/06; G06F 15/173

(52) U.S. Cl. CPC H04L 65/1093; G06F 15/17325
USPC 709/203

(57) ABSTRACT

A clustered device synchronization and output system, and method of use, has a session server having a system program. The system program performs the following steps: starting a session and associating a predefined location and/or a unique identifier with the session; receiving a request from the computer device via the network to join the session; determining whether the computer device is within the predefined location, and/or receiving the unique identifier from the computer device; operably joining the computer device with the session; receiving session data from the computer device; and sharing the session data with the plurality of computer devices that are operably joined with the session.

### CROSS-REFERENCE TO RELATED APPLICATIONS

This application for a utility patent claims the benefit of U.S. Provisional Application No. 61/956,919, filed Jun. 20, 2013.

### BACKGROUND OF THE INVENTION

### Field of the Invention

This invention relates generally to computer device systems, and more particularly to clustered computer device systems that organize computer devices into clusters of players participating in an event, tournament, or similar group event.

### SUMMARY OF THE INVENTION

The present invention teaches certain benefits in construction and use which give rise to the objectives described below.

The present invention provides a clustered device synchronization and output system, and a method of use of the system for synchronizing session data with multiple clustered computer devices. The system is operably connected via a network to the plurality of computer devices, e.g., mobile phones, tablets, and the like, for administering an application or game. The clustered device synchronization and output system comprise a session server having a computer processor, a computer memory, and a database; and a system program operably installed on the computer memory of the session server for performing various steps, including: starting a session and associating a predefined location and/or a unique identifier with the session; receiving a request from the computer device via the network to join the session; determining whether the computer device is within the predefined location, and/or receiving the unique identifier from the computer device; operably joining the computer device with the session; receiving session data from the computer device; and sharing the session data with the plurality of computer devices that are operably joined with the session.

A primary objective of the present invention is to provide a clustered computer device system and method of use having advantages not taught by the prior art.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a block diagram of a clustered device synchronization and output system according to one embodiment of the present invention;

FIG. 2 is another block diagram of the clustered device synchronization and output system, illustrating a session server that enables the system in one embodiment of the invention;

FIG. 3 is a block diagram of one embodiment of a computer device used to access the system;

FIG. 4 is a screen shot of one embodiment of session data being shared with the computer devices, and other display devices, utilizing the system; and

FIG. 5 is a screen shot of one embodiment of an application or game utilized by the system, in this case a golf game.

### DETAILED DESCRIPTION OF THE INVENTION

The above-described drawing figures illustrate the invention, a clustered device synchronization and output system (the “system”) that allows multiple players of a mobile game or application (“app”), on different computer devices, to sync to a specific session. The system enables the various computer devices to be able to send the session and the game/app information back and forth from the computer devices to a session server.

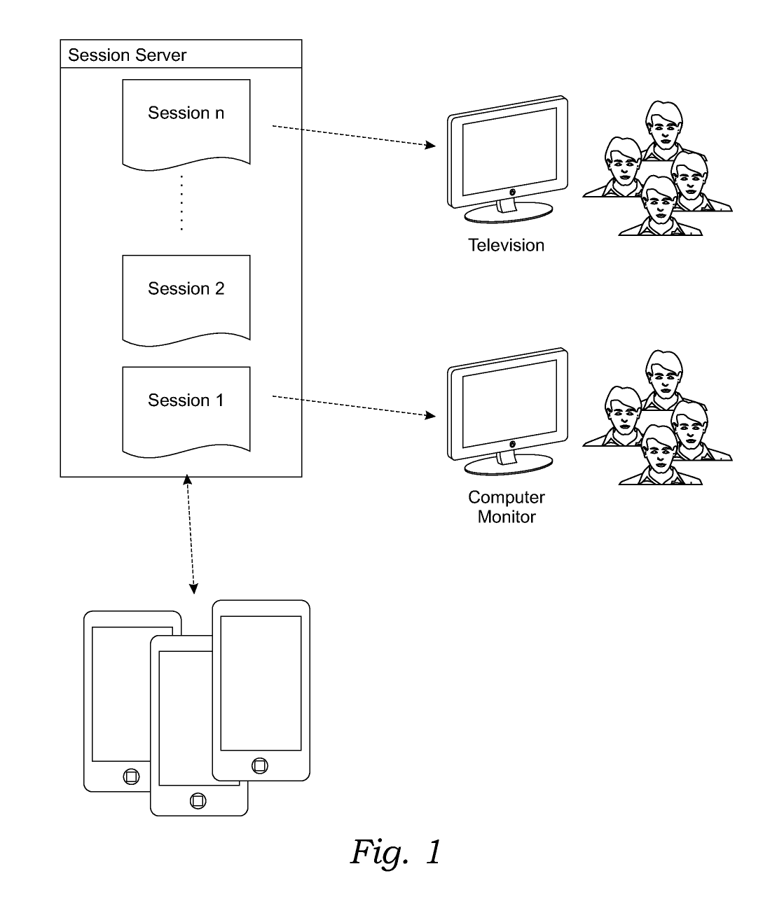

FIG. 1 is a block diagram of a clustered device synchronization and output system according to one embodiment of the present invention. As shown in FIG. 1, the system creates and defines a session, or plurality of sessions, that can be joined by the computer devices. The session is defined as an application, game, event, or group of events, that can be accessed only by authorized users at particular events (e.g., tournaments, fundraisers, sweepstakes, etc.). The session data captured from each of the users is then displayed and/or disseminated to the various computer devices included in the session. The session data may include, for example, scores, player statistics, and other data available and made accessible on the computer devices.

The players may access the session using one or more alternative methods. In one embodiment, the session is entered by entering a unique identifier (e.g., a unique code, an email address that has been authorized, or other similar identifier, using methods known in the art). The system then synchronizes the device data on the computer device of the user with the session server, which then includes this device data to the other computer devices included in the session. The computer device of the authorized user is then also able to review all of the data related to the authorized session.

In another embodiment, the session is entered by being physically located in a predetermined physical location. In this embodiment, an administrator may define the predetermined physical location, also known as a geofence, using techniques known in the art. The geofence may include an area within a certain distance from a specified location, or an area within certain defined boundaries (longitude/latitude, between certain streets, within a certain zip code, etc.), or within another location (park, arena, fairground, etc.). Location data that defines the specified location is then stored in the session server, e.g., in the database, associated with the session, and the session is started.

Once the session has been defined, and the predetermined location defined, the system is then able to receive requests from the computer devices, e.g., via the network, to join the session. The location of the computer device is determined, and the session server then determines if the computer device is within the predefined location. If the computer device is within the predefined location, the computer device is operably joined with the session. If not, it is denied access to the session.

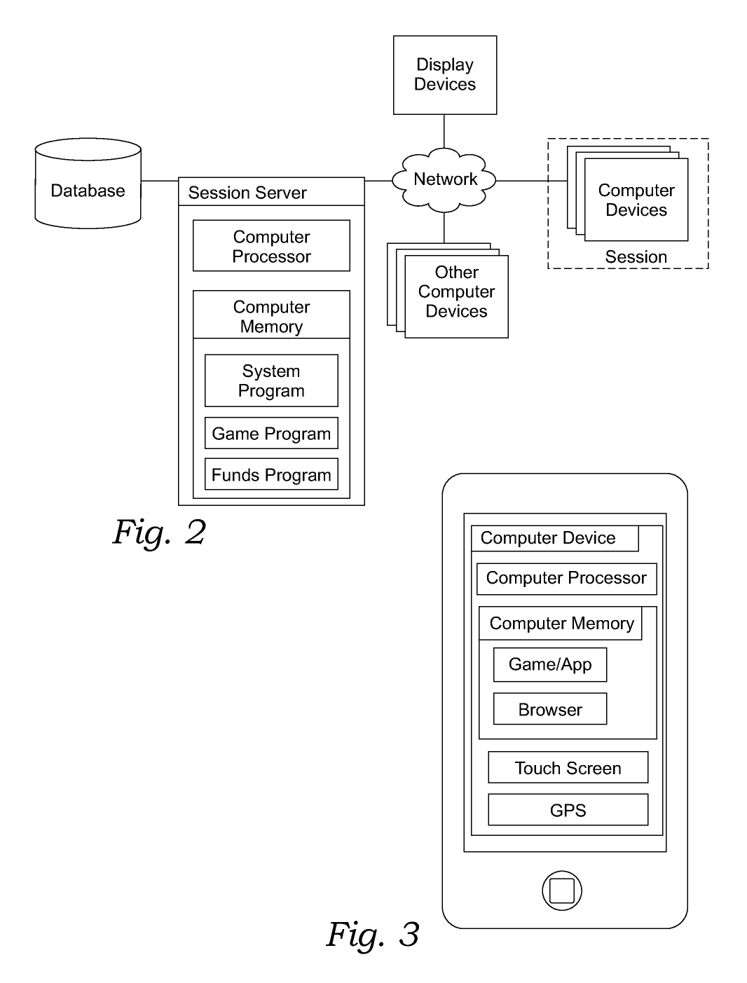

FIG. 2 is another block diagram of the clustered device synchronization and output system, illustrating a session server that enables the system in one embodiment of the invention. As shown in FIG. 2, the system of FIG. 1 may include a session server (or group of servers) that operate software for administering the sessions. In one embodiment, the session server is operably connected via a network to the plurality of computer devices for administering the application.

The session server is of standard construction, and includes a computer processor, a computer memory, and a database. As used in this application, the terms computer, processor, memory, and other computer related components, are hereby expressly defined to include any arrangement of computer(s), processor(s), memory device or devices, and/or computer components, either as a single unit or operably connected and/or networked across multiple computers (or distributed computer components), to perform the functions described herein.

A system program is operably installed on the computer memory of the session server for performing the functions of the system. In the embodiment of FIG. 2, the system program first determines whether the computer device meets the requirements to enter the session. As discussed above, the system program may determine whether the computer device is located within the physical location defined (i.e., within the geofence), or whether the user can provide a necessary code, to prove that he or she should have access to the session.

Once admitted to the session, the session data is received from the computer device, and shared with any computer devices operably joined with the session. The session data may include a wide range of data about the session. For example, when a game is being played, scores, rankings, times, and other data, may be shared. Not only is the session data available for display in the computer devices, it may also be displayed in various display devices (e.g., televisions, computer monitors, and other forms of displays that are authorized to receive the session data). When the system is being used in a tournament or similar event, the display devices may be provided in suitable locations throughout the tournament, so that those physically present may view the standings of those participating in the tournament.

FIG. 3 is a block diagram of one embodiment of a computer device used to access the system. As illustrated in FIG. 3, the computer device may be any form of computer, including mobile devices, such as mobile phones, tablets, laptops, and also desktop computers, and any other form of device known in the art. The computer device includes a computer processor and memory, such as is well known in the art.

The game or application (referred to as an “App”) may be operably installed in the memory of the computer device, for playing or otherwise participating in the session. The App may be downloaded an installed using techniques well known in the art, and may enable joining a session as discussed above. A browser or similar program may also be operatively installed, for accessing the game, and/or for otherwise joining the session. Other programs and techniques may also be used, using systems and methods known in the art.

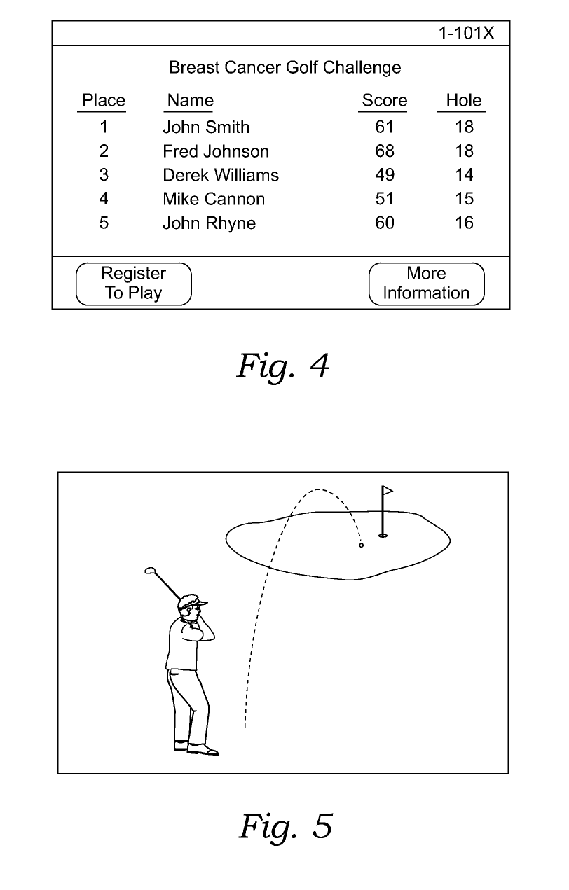

FIG. 4 is a screen shot of one embodiment of session data being shared with the computer devices, and other display devices, utilizing the system. As illustrated in FIG. 4, in this embodiment, the session data includes information about the top players in a tournament, and information about the progress of the players through the tournament (what hole they are on, or have completed). Obviously, the session data can vary a great deal depending upon the application or game being utilized.

FIG. 5 is a screen shot of one embodiment of the app, in this case a golf game, utilized by the system. In this app, the user is able to play virtual golf, using systems and methods known in the art.

In the embodiment of FIGS. 4-5, the clustered device synchronization and output system is a fundraising event game system that utilizes the golf game described above. Players are all located at the predefined location, in this case a golf course, and pay fees for raising funds for a charitable cause. Some players may play physical games of golf, and others may play virtual games of golf, and all participants may track the progress of the other players, via the app.

As used in this application, the words “a,” “an,” and “one” are defined to include one or more of the referenced item unless specifically stated otherwise. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

What is claimed is:

1. A clustered device synchronization and output system operably connected via a network to a plurality of computer devices for administering an application or game, the clustered device synchronization and output system comprising:
a session server having a computer processor, a computer memory, and a database; and
a system program operably installed on the computer memory of the session server for performing the following steps:
starting a session and associating a predefined location and/or a unique identifier with the session;
receiving a request from the computer device via the network to join the session;
determining whether the computer device is within the predefined location, and/or receiving the unique identifier from the computer device;
operably joining the computer device with the session;
receiving session data from the computer device; and
sharing the session data with the plurality of computer devices that are operably joined with the session.

2. A method for synchronizing a plurality of computer devices into a cluster for displaying session data to all of the plurality of computer devices within the cluster;
providing a session server having a computer processor, a computer memory, and a database;
installing a system program on the computer memory of the session server;
starting a session within the system program on the session server;
associating a predefined location and/or a unique identifier with the session;
receiving a request from one of the computer devices by the session server to join the session;
determining whether the computer device is within the predefined location, and/or receiving the unique identifier from the computer device;
operably joining the computer device with the session;
receiving the session data from the computer devices that have been joined with the session; and
sharing the session data with the plurality of computer devices that are operably joined with the session.

3. A fundraising event game system operably connected via a network to a computer device for administering a game at a predefined location for raising funds for a charitable cause, the fundraising event game system comprising:
a session server having a computer processor, a computer memory, and a database;
a system program operably installed on the computer memory of the session server for performing the following steps:
receiving location data that defines the predefined location;
storing the location data in the database;
starting a session and associating the predefined location with the session;
receiving a request from the computer device via the network to join the session;
determining the location of the computer device;
determining if the computer device is within the predefined location;
operably joining the computer device with the session;
receiving session data from the computer device; and
sharing the session data with any computer devices operably joined with the session.
